(19) United States
(12) Patent Application Publication
(10) Pub. No.: US 2024/0378845 A1
(43) Pub. Date: Nov. 14, 2024

(54) IMAGE PROCESSING APPARATUS, CONTROL METHOD, AND STORAGE MEDIUM

(71) Applicant: CANON KABUSHIKI KAISHA, Tokyo (JP)

(72) Inventor: TOSHIHIRO IWATA, Kanagawa (JP)

(21) Appl. No.: 18/652,696

(22) Filed: May 1, 2024

(30) Foreign Application Priority Data
May 8, 2023 (JP) 2023-076735

(51) Int. Cl. G06V 10/26; G06V 10/25; G06V 10/94; G06V 40/10

(52) U.S. Cl. CPC G06V 10/267; G06V 10/25; G06V 10/945; G06V 40/10

(57) ABSTRACT

An image processing apparatus includes one or more processors and one or more memories. The one or more processors and the one or more memories are configured to acquire a first image including a plurality of objects, detect the objects in the first image, set an object of interest from the objects, determine a first region in the first image to include the object of interest based on positions of the objects, generate a second image based on the first region, and determine a respective second region, indicating a position and a region, of each of the objects in the first image.

### BACKGROUND

### Field of the Disclosure

The present disclosure relates to an image processing apparatus performing image processing on an image, a control method, and a storage medium.

### Description of the Related Art

A technique for generating a new image by clipping a part of an image acquired by a camera has been known. For example, Japanese Patent No. 6447659 discusses a technique for clipping an image by detecting directions and positions of faces included in a captured image and detecting a designated face and faces directed to the same direction as the designated face as one group. Japanese Patent Application Laid-Open No. 2018-151979 discusses a technique for determining a clip position by determining a moving amount of a region based on a type of a scene.

However, in the technique discussed in Japanese Patent No. 6447959, faces not included in the group are not considered. For this reason, when the image is clipped, the faces not included in the group may be cut off.

In the technique discussed in Japanese Patent Application Laid-Open No. 2018-151979, the region is set based on an object to be followed. Thus, the relationship between objects not to be followed around the object to be followed and the set region is not considered. For this reason, when the image is clipped, the objects not to be followed around the object to be followed may be cut off.

### SUMMARY

Some embodiments of the present disclosure are directed to a technique for preventing an object of interest and objects around the object of interest from being cut off when an image is clipped.

According to an aspect of the present disclosure, an image processing apparatus includes one or more processors and one or more memories. The one or more processors and the one or more memories are configured to acquire a first image including a plurality of objects, detect the objects in the first image, set an object of interest from the objects, determine a first region in the first image to include the object of interest based on positions of the objects, generate a second image based on the first region, and determine a respective second region, indicating a position and a region, of each of the objects in the first image.

Further features of various embodiments will become apparent from the following description of exemplary embodiments with reference to the attached drawings.

### BRIEF DESCRIPTION OF THE DRAWINGS

FIG. 1 illustrates an example of a configuration of an image processing system according to a first exemplary embodiment.

FIG. 2A illustrates an example of a hardware configuration of an image processing apparatus according to the first exemplary embodiment, and FIG. 2B illustrates an example of a functional configuration of the image processing apparatus according to the first exemplary embodiment.

FIG. 3A illustrates an example of an image used for person recognition data, and

FIG. 3B illustrates an example of the person recognition data.

FIG. 4 illustrates a setting example of object regions of a person according to the first exemplary embodiment.

FIG. 5 is an exemplary flowchart of processing by the image processing apparatus according to the first exemplary embodiment.

FIG. 6 is an exemplary flowchart of processing for determining a clip region according to the first exemplary embodiment.

FIG. 7A illustrates an example of the clip region in the processing for determining the clip region according to the first exemplary embodiment, and FIG. 7B illustrates an example of the person recognition data used for determining the clip region according to the first exemplary embodiment.

FIG. 8 illustrates an example of the clip region acquired from human body detection processing in image clipping processing according to the first exemplary embodiment.

FIG. 9 illustrates an example of the clip region in consideration of an aspect ratio in the image clipping processing according to the first exemplary embodiment.

FIG. 10 illustrates an example of a user interface of the image processing system according to the first exemplary embodiment.

FIG. 11 illustrates an example of a configuration of an image processing system according to a second exemplary embodiment.

### DESCRIPTION OF THE EMBODIMENTS

Some exemplary embodiments are to be described with reference to accompanying drawings. The exemplary embodiments described below are examples in a case where the present disclosure is specifically implemented, and are specific exemplary embodiments of configurations described in the claims. In the drawings, the same members are denoted by the same reference numerals, and repetitive description is omitted.

In a first exemplary embodiment, positions of objects and object regions are detected in an image, and a clip region including an object of interest is determined in consideration of the detected object regions. The image is clipped based on a result of the determination, and a moving image including the object of interest is generated.

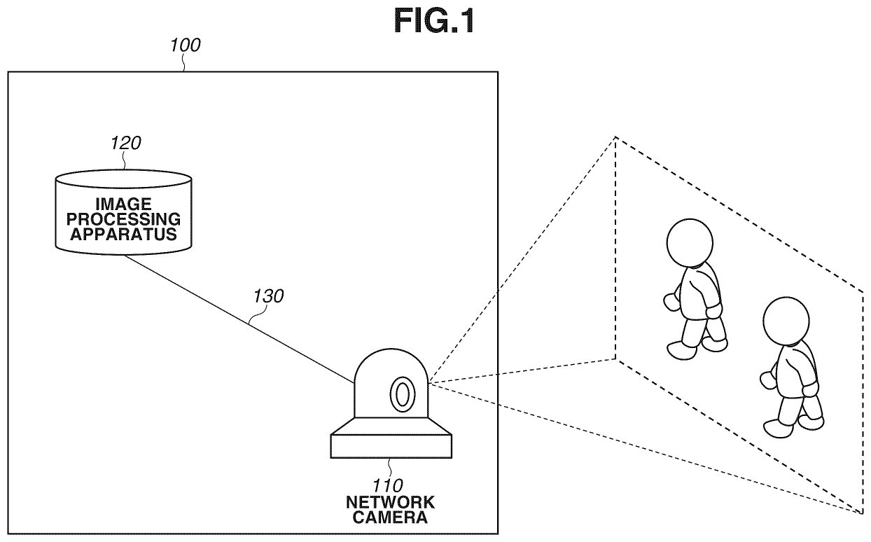

A configuration example of a system according to the present exemplary embodiment is to be described with reference to FIG. 1. FIG. 1 illustrates an example of a configuration of an image processing system 100 according to the first exemplary embodiment. As illustrated in FIG. 1, the image processing system 100 according to the present exemplary embodiment mainly includes a network camera 110, an image processing apparatus 120, and a network 130.

The network camera 110 is a camera that can transmit a control signal through serial communication or internet protocol (IP) communication, or transmit a moving image by an analog/digital signal. The network camera 110 can distribute a moving image to an external apparatus, set various kinds of internal parameters and control the camera. The network camera 110 can record moving image data in an external memory, such as an SD card.

The image processing apparatus 120 is connected to the network camera 110, and can control the camera and receive the distributed moving image. The image processing apparatus 120 includes an application, such as a web browser; can display the moving image distributed from the network camera 110 and a setting screen on a display unit to be described below; and can control the camera. In addition, the image processing apparatus 120 can operate viewing of the moving image recorded in the image processing apparatus 120, and control of moving image generation performed in the image processing apparatus 120. The image processing apparatus 120 can store a moving image captured by the network camera 110, and generate a moving image subjected to image clipping processing based on the captured moving image. The image processing apparatus 120 can acquire the moving image from the network camera 110 through the network 130 to be described below, and store the moving image in an internal memory. The image processing apparatus 120 can also acquire data from an external memory, such as an SD card, and acquire moving image data recorded by the network camera 110 from the external memory.

The network 130 is a network for communication of the network camera 110 and the image processing apparatus 120. The form of communication may be wired communication or wireless communication without limitation as long as the moving image and the control signal can be transmitted by serial communication or IP communication.

### <Description of Configuration of Image Processing Apparatus>

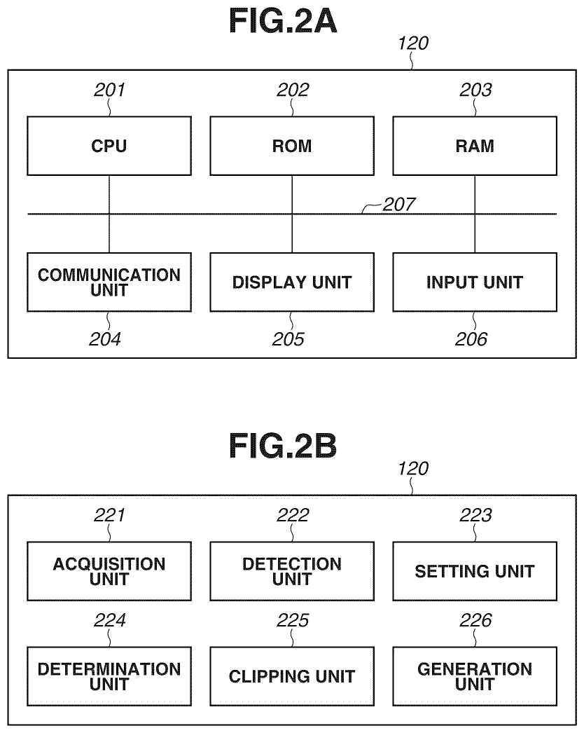

A hardware configuration example of the image processing apparatus according to the exemplary embodiment of the present disclosure is to be described with reference to FIG. 2A. FIG. 2A illustrates an example of a hardware configuration of the image processing apparatus 120 according to the first exemplary embodiment. The image processing apparatus 120 includes a central processing unit (CPU) 201, a read only memory (ROM) 202, a random access memory (RAM) 203, a communication unit 204, a display unit 205, an input unit 206, and an internal bus 207 that communicably connects the above-described components.

The CPU 201 controls the whole of the image processing apparatus 120 by executing control programs stored in the ROM 202 to be described below, to control the components of the image processing apparatus 120. The CPU 201 can acquire image data from the communication unit 204 to be described below.

The ROM 202 is a nonvolatile storage device represented by a flash memory, a hard disk drive (HDD), a solid state drive (SSD), and an SD card. The ROM 202 is used as a permanent storage region for an operating system (OS), various kinds of programs, and various kinds of data, and is also used as a temporary storage region for various kinds of data.

The RAM 203 is a high-speed volatile storage device represented by a dynamic RAM (DRAM). The OS, various kinds of programs, and various kinds of data are loaded to the RAM 203, and the RAM 203 is used as a work region for the OS and the various kinds of programs. The RAM 203 develops the programs so that the programs are executable by the CPU 201.

The communication unit 204 communicates with the network camera 110 to acquire moving image data. As an interface for receiving the moving image data, for example, a general-purpose input interface such as a high-definition multimedia interface (HDMI®), a serial digital interface (SDI), and DisplayPort, and a local area network (LAN) connected to the network are assumed. The communication unit 204 outputs a moving image (output moving image) generated by a generation unit 226 to be described below, to an external apparatus (not illustrated). Examples of the external apparatus include a display, a moving image transmission apparatus for television (TV) broadcasting and Internet broadcasting, and a recording apparatus for a universal serial bus (USB) and a digital versatile disk (DVD).

The display unit 205 includes a cathode-ray tube (CRT) and a liquid crystal screen, and can display an image acquired by the communication unit 204 and a processing result of the image processing apparatus 120 by using an image, characters, and the like.

The input unit 206 includes a user interface, such as a keyboard, a mouse, and a touch panel. A user can input various kinds of instructions to the image processing apparatus 120 by operating the input unit 206. In FIG. 1, these components are integrated into one apparatus, but the configuration is not limited to this example. For example, the components may be configured as different apparatuses, the display unit 205 and the input unit 206 may be integrated, or the communication unit 204 and the display unit 205 may be integrated.

A functional configuration example of the image processing apparatus 120 is to be described with reference to a block diagram illustrated in FIG. 2B. Functional units illustrated in FIG. 2B may be implemented as hardware, or may be implemented as software (computer programs). In a latter case, the computer programs are stored in the RAM 203. The CPU 201 realizes functions of the corresponding functional units by loading the computer programs to the ROM 202 and executing the computer programs as necessary.

An acquisition unit 221 acquires various kinds of instructions input by the user through operation of the input unit 206. The acquisition unit 221 further acquires a moving image from an external apparatus (image acquisition unit).

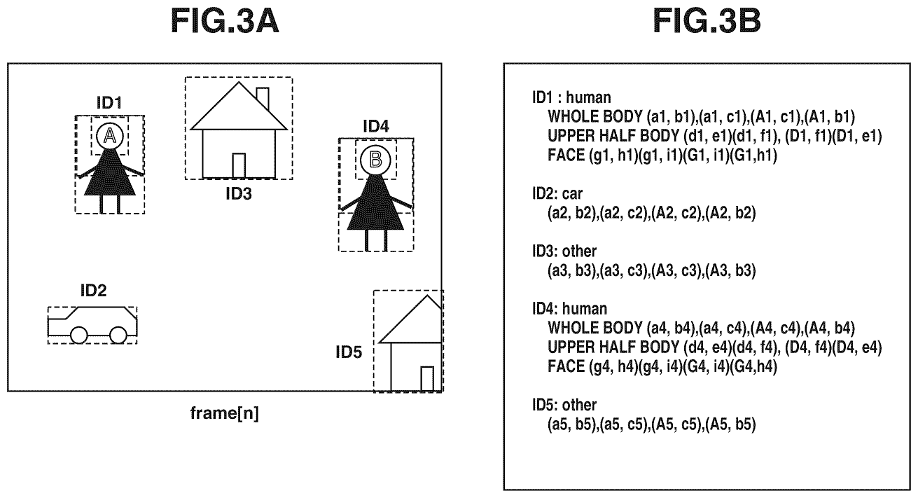

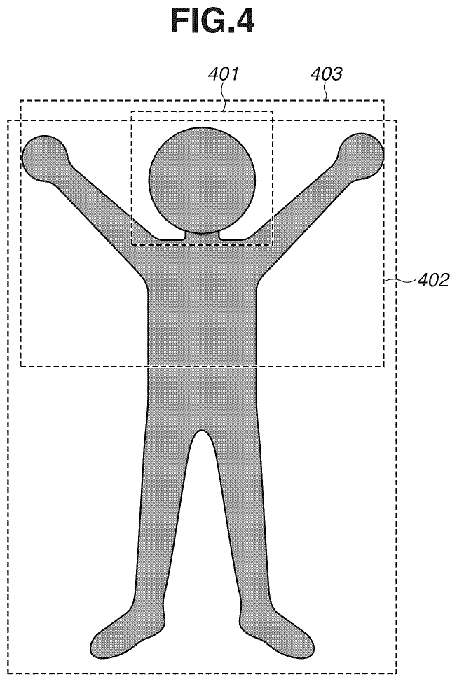

A detection unit 222 includes a trained model created using a machine learning method, such as deep learning, and detects objects from a moving image or a still image acquired by the acquisition unit 221. The detection unit 222 receives an image as input data, assigns unique identifications (IDs) to the objects identified from positional relationship of the detected objects among frames, and outputs, as person recognition data, a score indicating attributes of the objects such as a person, and object regions in association with a frame number. At this time, a subject position is represented by information expressed in pixels [pix] based on the resolution of the captured image. In a case where the moving image has FHD resolution of 1920×1080 and has a reference position of X:0 and Y:0 at a lower left corner, and a subject (barycenter of subject) is positioned at a center of the image, positional information of the subject is represented by X:960 and Y:540. In a case where the positional information about the subjects among the frames are approximate by more than a predetermined value, the detection unit 222 identifies the subjects as the same object, and assigns a unique ID to the object. At this time, the detection unit 222 may identify the object from information on attributes, colors, and the like of the objects in addition to the positional information. FIG. 3A illustrates an image (entire image) acquired as the input data from the acquisition unit 221, and FIG. 3B illustrates the person recognition data indicating the unique IDs, the attributes, and the object regions of the detected objects. At this time, in a case where any of the object regions to be described below are coincident with any of the ends of the entire image, the object is excluded from targets of clip region determination processing. For example, in a case where the resolution is the FHD resolution of 1920×1080 and a lower left corner is the reference position of X:0 and Y:0, the end of the entire image indicates a position in which at least one of coordinates [pix] is X:0 or 1920, or Y:0 or 1080. In FIG. 3B, an object region of an object having ID5 is coincident with a right end and a lower end of the entire image. In this case, the object region of the object having ID5 is acquired, but is excluded from a clip region of a determination unit 224 to be described below. The attribute of the object indicates a person (male or female), an animal, an immovable body, and the like. The attribute is determined from shape characteristics and a pattern of action characteristics. The object region (second region) is a region set (determined) so as to include the whole of the detected object. The detection unit 222 can determine the object regions by dividing the detected object into some parts. For example, in a case of a person, the detection unit 22 divides one object into three parts of a face region 401, an upper half body region 402, and a whole body region 403 as illustrated in FIG. 4 and outputs information on the position of the object. The object detection method described here is illustrative, and the method is not limited as long as a necessary object can be detected based on an imaging purpose and an environment. The method of determining the attribute of the object is not limited to the above-described method, and any method can be used as long as the attribute can be determined, for example, the attribute is determined by specific object detection processing using edge characteristics.

A setting unit 223 sets an object of interest from the person recognition data output from the detection unit 22. The user may select and determine the object of interest from a list of objects displayed on the display unit 205.

A determination unit 224 sets an image clip region based on the object region of the object of interest and clip region information. More specifically, the determination unit 224 determines the image clip region by repeatedly determining the clip region based on the object region of the object of interest set by the setting unit 223 and setting information (clip region information) about the clip region (first region). The clip region information includes various kinds of preset conditions. The various kinds of conditions of the clip region information include the number and attributes of objects to be included in the clip region, priority, the object region of the object of interest to be included in the clip region, and information about an aspect ratio. The various kinds of conditions of the clip region information are stored in the ROM 202, and are referred to in response to the processing by the determination unit 224. Only the conditions may be stored in the ROM 202, and the determination unit 224 may select either using or not using the conditions for the processing. The clip region information may be determined by the user through the input unit 206, or may be determined in the image processing apparatus 120.

A clipping unit 225 performs clipping processing on the image (entire image) acquired by the acquisition unit 221 based on the clip region determined by the determination unit 224.

The generation unit 226 generates a moving image based on the frame number labeled by the above-described setting unit 223, information on the object regions in the image, and the image clipped by the clipping unit 225. The image processing apparatus 120 further includes an internal bus that communicably connects the above-described components.

### <Description of Basic Processing by Image Processing Apparatus>

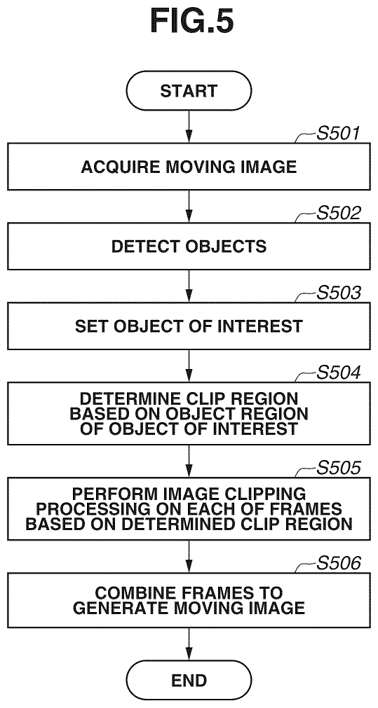

A basic processing procedure in the image processing apparatus 120 according to the present exemplary embodiment is to be described with reference to a flowchart illustrated in FIG. 5. In the present exemplary embodiment, a person is set as a target to be detected, but a vehicle, an animal, or the like other than a person may be set as a target to be detected, or a plurality of attributes, such as a person and an animal, may be set as targets to be detected.

The object may be detected by using feature point detection or other method.

The control flow is started when the acquisition unit 221 acquires an instruction to generate a moving image input from the input unit 206.

In step S501, the communication unit 204 acquires a moving image to be processed. The acquisition method is not limited to any specific method as long as the image data can be acquired. For example, image data may be recorded in a detachable external memory, such as an SD card, and the image data may be transmitted to the communication unit 204.

In step S502, the detection unit 222 detects objects in each of frames of the acquired moving image, and stores a score indicating attributes of objects, such as persons, and object regions as the person recognition data in the ROM 202. These objects to be detected can be set by the user through the input unit 206.

In step S503, the setting unit 223 determines the object of interest from the objects detected in step S502. The user may select and determine the object of interest from a plurality of preset objects. In this case, detection information on the objects detected in step S502 is read out, and is converted into data to be displayed on the display unit 205. Further, the detection unit 222 labels the object of interest set in each of the frames of the image data based on the person recognition data stored in the ROM 202 in step S502. In a case of a person, person authentication can be performed by providing information on gender and age, or previously providing training data on a specific person, and the object of interest may be determined using the person authentication. In a case where the object of interest set by the setting unit 223 is not detected from the frames, no processing is performed in steps S504 and S505.

In step S504, the determination unit 224 sets the image clip region based on the object region of the object of interest set by the setting unit 223 in step S503 and the clip region information. More specifically, the clip region is determined using the object region of the object of interest determined in step S503 and setting information about the clip region (clip region information). The clip region information includes various kinds of preset conditions. The various kinds of conditions of the clip region information include the number and attributes of objects to be included in the clip region, priority, the object region of the object of interest, information about an aspect region, a rate of an area of a face region to an area of the clip region, and a rate of the area of the clip region to an area of the entire image. The clip region information may be determined by the user through the display unit 205, or may be determined in the image processing apparatus 120. Details of the method of determining the clip region are to be described below.

In step S505, the clipping unit 225 performs the image clipping processing on each of the frames based on the clip region set in step S504, and stores clipped images in the ROM 202.

In step S506, the generation unit 226 combines the plurality of labeled frames based on the images clipped in step S505 and the person recognition data stored in step S502.

When one moving image including the plurality of labeled frames is generated, the control flow ends. The frames used to generate the moving image are frames including the object of interest, and all of the frames of the acquired moving image may not be used. For example, in a case where a frame not including the person of interest is present in the acquired moving image, the frame may not be included in the generated moving image, or a moving image including all of the frames may be generated. In a case where the moving image including all of the frames is generated, the moving image can be generated using the frame not subjected to the clipping processing.

### <Method of Setting Clip Region>

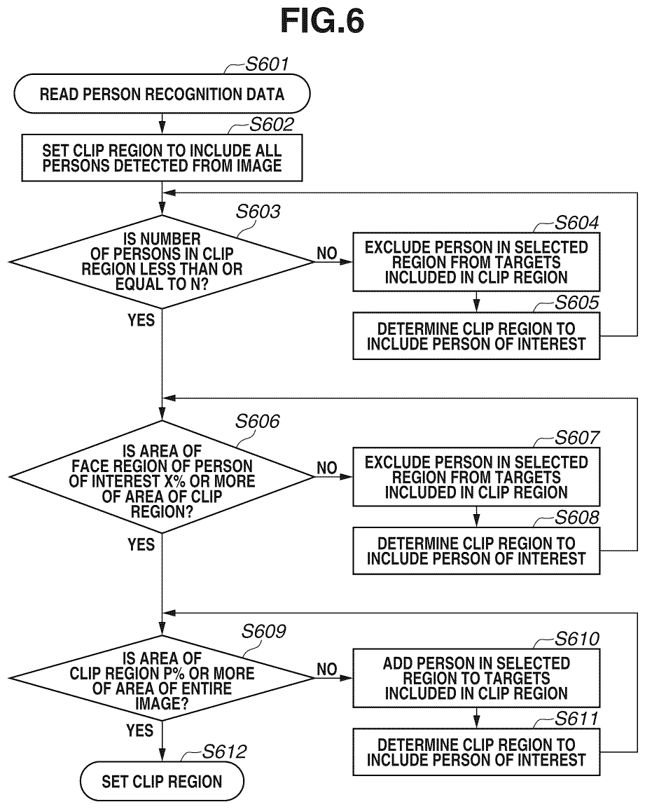

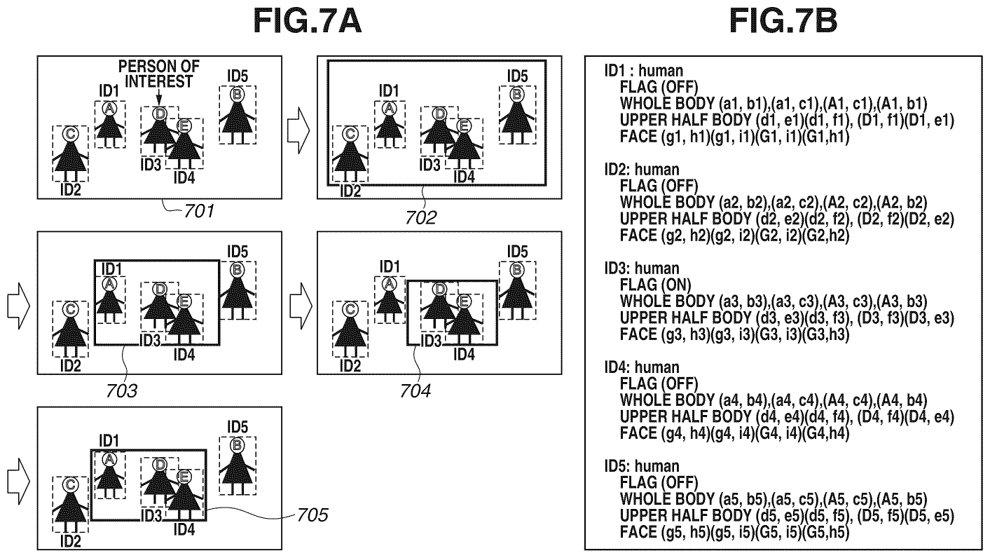

A specific procedure of the method of determining the clip region in each of the frames according to the present exemplary embodiment is to be described with reference to a flowchart illustrated in FIG. 6, and FIGS. 7A and 7B, FIG. 8, and FIG. 9.

In the present exemplary embodiment, the control flow illustrated in FIG. 6 is details of the processing in steps S503 and S504 illustrated in FIG. 4 performed in the image processing apparatus 120. In the present exemplary embodiment, a case where the clip region of an input image 701 (entire image) illustrated in FIG. 7A is determined is to be described.

In step S601, the label (person recognition data) of the objects and the object of interest corresponding to each of the frames of the moving image is read from the ROM 202, and the object regions of the detected objects in the image are acquired.

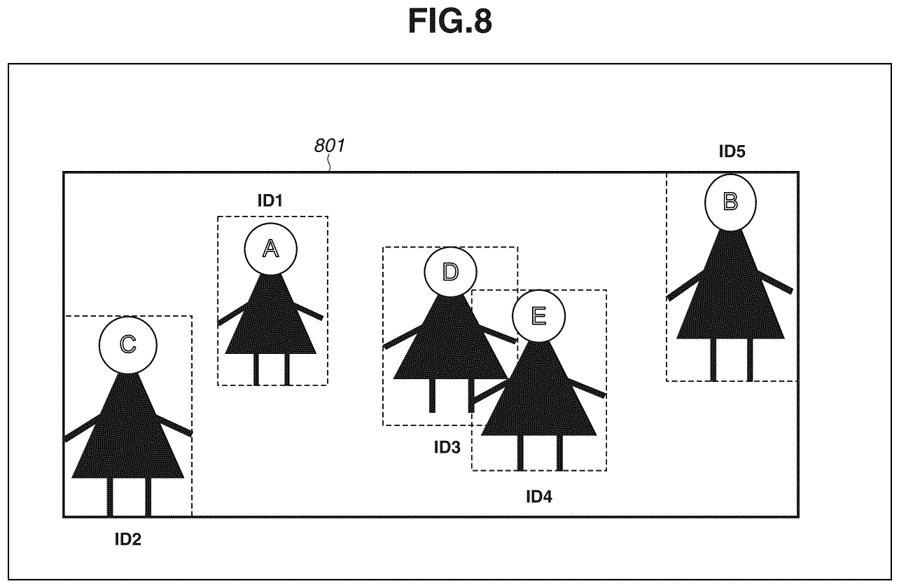

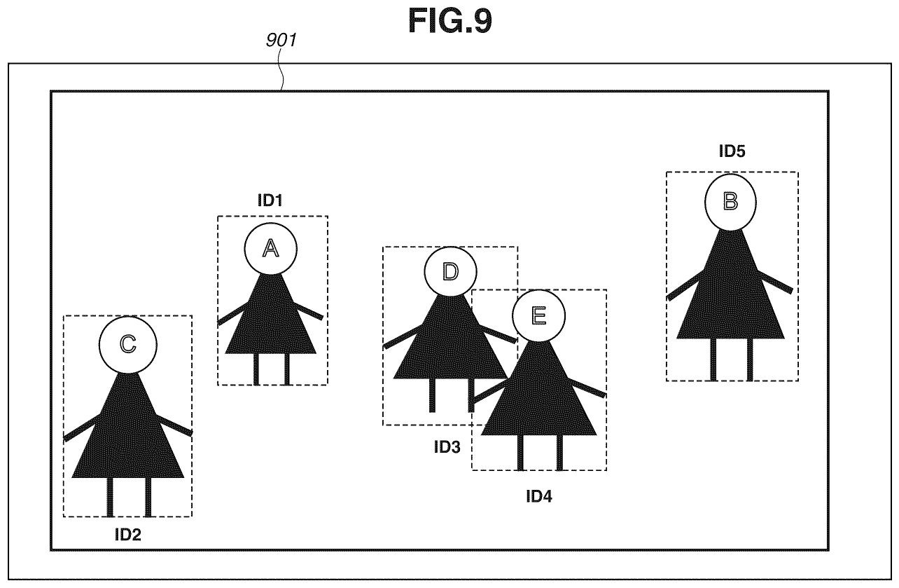

In step S602, the clip region is set so as to include the object regions of all objects detected from the image 701 (entire image) illustrated in FIG. 7A. The clip region is set using coordinates of an end of the object region positioned at any of the ends in the entire image based on the person recognition data. For example, processing in a case where persons A to E are present in the image as illustrated in FIG. 7A is considered. The person recognition data illustrated in FIG. 7B indicates the ID, the attribute, a flag indicating whether the person is a person of interest, and coordinates [pix] of the object region of each of the detected persons. The coordinates of each of the object regions indicate coordinates at an upper left corner, a lower left corner, a lower right corner, and an upper right corner in order from the left. To set the clip region so as to include the object regions of all persons, the coordinates at the upper left corner, the lower left corner, the lower right corner, and the upper right corner of the clip region are determined. The coordinates at the upper left corner, the lower left corner, the lower right corner, and the upper right corner of the clip region are determined based on the object regions of the objects. In a case of FIGS. 7A and 7B, the Y coordinates of the object regions are compared. An upper left corner (a2, b2) and an upper right corner (A2, b2) of the person B are positioned at the uppermost end. Accordingly, an upper end of the clip region is set based on a position of an upper end of the object region of the person B. Likewise, in a case of a lower end, a lower left corner (a3, c3) and a lower right corner (A3, c3) of the person C are positioned at the lowermost end. Accordingly, a lower end of the clip region is set based on a lower end of the object region of the whole body of the person C. In a case of a left end, an upper left corner (a3, b3) and a lower left corner (a3, c3) of the person C are positioned at the leftmost end. Accordingly, a left end of the clip region is set based on a left end of the object region of the whole body of the person C. Likewise, in a case of a right end, an upper right corner (A2, b2) and a lower right corner (A2, c2) of the person B are positioned at the rightmost end. Accordingly, an upper end of the clip region is set based on a right end of the object region of the whole body of the person B. As a result, a clip region 801 illustrated in FIG. 8 is determined. Finally, to maintain an aspect ratio of the original image, the clip region 801 is corrected to a clip region 901 illustrated in FIG. 9 by adjusting an aspect ratio of the clip region 801 to the aspect region of the original image. More specifically, the clip region information is acquired from the ROM 202, the aspect ratio of the entire image is referred to, and the clip region is widened in vertical and horizontal directions so as to be matched with the aspect ratio in FIG. 9. For this reason, in the case of the input image 701 illustrated in FIG. 7A, a clip region 702 is obtained by the processing in step S602. In the present exemplary embodiment, processing in and after step S603 is performed, but in a case where the setting information about the clip region (clip region information) does not include information on the number of objects, the processing may end at step S602.

In step S603, the number of objects (number of persons in this example) included in the clip region is counted. Further, the clip region information is read out from the ROM 202, and determination about the number of objects (number of persons) is performed. In a case where the number of objects (number of persons) in the clip region is greater than N (NO in step S603), the processing proceeds to step S604. In a case where the number of objects (number of persons) in the clip region is less than or equal to N (YES in step S603), the processing proceeds to step S606.

In step S604, the clip region set in step S602 is changed such that the number of persons in the clip region becomes less than or equal to N. In the present exemplary embodiment, the number of persons to be included in the clip region is previously set by the user through the input unit 206, but this is illustrative, and the number of persons may be automatically set in the image processing apparatus 120.

At this time, at least one object region is selected, and the selected object region is excluded from the clip region. The object region is selected in order from the object region farthest from the person of interest. For example, in a case where the number of objects (number of persons) previously set is three in the state of the clip region 702, the person C farthest from the person of interest D, and the person B second farthest from the person of interest D are excluded to select the object regions included in the clip region set in step S602. The method of setting the persons described in the present exemplary embodiment is illustrative, and another method may be used. For example, the person farthest from the person of interest in a direction opposite to an advancing direction of the person of interest may be set based on a direction of a face of the person of interest and information on a motion vector from a previous frame. The user may set the object to be preferentially set, from the detected objects.

In step S605, the clip region is determined based on the setting of the object regions selected in step S604, and the aspect ratio of the clip region is adjusted to the aspect ratio of the entire image. The method of determining the clip region is similar to the method in step S602, and description of the method is omitted. Accordingly, when a clip region is determined in the clip region 702 so as not to include the object regions of the persons determined in step S604, a clip region 703 is obtained as a processing result. In the present exemplary embodiment, processing in and after step S606 is performed, but in a case where the setting information about the clip region (clip region information) does not include information on a rate of an area of a face region to an area of the clip region, the processing may end at step S605.

In step S606, a rate of an area of a face region of the object of interest to an area of the clip region determined in step S605 is calculated. The clip region information is read out from the ROM 202, and determination about the rate of the face region is performed. In a case where the rate is less than X % (threshold) (NO in step S606), the processing proceeds to step S607. In a case where the rate is greater than or equal to X % (YES in step S606), the processing proceeds to step S609.

In step S607, the clip region is determined such that the area of the face region of the object of interest exceeds X % of the area of the clip region determined in step S605. More specifically, among the object regions included in the clip region in step S606, at least one object region is excluded such that the area of the face region of the object of interest exceeds X %, to select the object regions included in the clip region in step S605. Thereafter, the processing proceeds to step S608. In the present exemplary embodiment, the threshold for the rate of the area of the face region is previously set by the user through the input unit 206, but this is illustrative, and the threshold may be automatically set in the image processing apparatus 120.

In step S608, the clip region is set so as to include the object regions of all persons to be included in the clip region set in step S607, and the aspect ratio of the clip region is adjusted to the aspect ratio of the entire image. The method of setting the clip region is similar to the method in step S602, and description of the method is omitted. Accordingly, when a clip region is set by excluding the persons determined in step S607 from the clip region 703, a clip region 704 is obtained as a processing result. In the present exemplary embodiment, processing in and after step S609 is performed, but in a case where the setting information about the clip region (clip region information) does not include information on a rate of an area of the clip region to an area of the entire image, the processing may end at step S608.

In step S609, a rate of an area of the clip region set in step S608 to an area of the entire image is calculated. The clip region information is read out from the ROM 202, and determination about the rate calculated in step S609 is performed. In a case where the rate is less than P % (threshold) (NO in step S609), the processing proceeds to step S610. In the present exemplary embodiment, the threshold for the rate of the area of the clip region to the area of the entire image is previously set by the user through the input unit 206, but this is illustrative, and the threshold may be automatically set in the image processing apparatus 120. For example, a resolution of a display device to which the image is output may be input, and a rate not deteriorating visibility with respect to the area of the entire image may be automatically calculated and set.

In step S610, the clip region is determined so as to include, among the object regions not included in the clip region in step S609, the object region of the object closest in distance to the object of interest in the entire image. The processing then proceeds to step S611. For example, the clip region is determined so as to include, among the persons A, C, and B not included in the clip region in the state of the clip region 704, the person A closest to the person of interest D. The method of adding the person described in the present exemplary embodiment is illustrative, and another method may be used. For example, the person advancing in the direction same as the advancing direction of the person of interest may be added based on the direction of the face of the person of interest and the information on the motion vector from the previous frame. The user may set the object to be preferentially added, from the detected objects.

In step S611, the clip region is set such that the rate of the area of the clip region determined in step S606 to the area of the entire image becomes greater than or equal to the threshold set in the clip region information.

The method of setting the clip region is similar to the method in step S602. The clip region is set so as to include the object regions of all persons to be included in the clip region set in step S610. Accordingly, when a clip region is set by adding the persons determined in step S610, a clip region 705 is obtained as a processing result.

In step S612, a frame is determined as the clip region, and the processing ends. The order, the number of times, the conditions, and the method of the procedure for resetting the frame according to the present exemplary embodiment are illustrative, and can be modified depending on an implementation purpose.

By the above-described configuration, the present exemplary embodiment can provide the technique for preventing the object of interest and the objects around the object of interest from being cut off when the image is clipped.

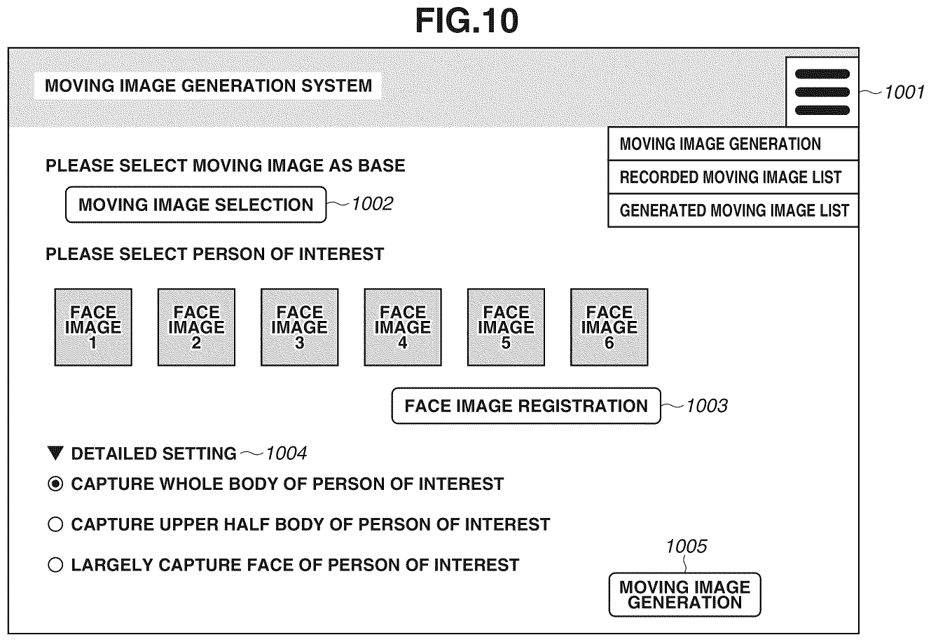

A user interface of the image processing apparatus 120 in the image processing system 100 is to be described with reference to FIG. 10.

First, the user accesses the generation unit 226 of the image processing apparatus 120 from the input unit 206. The user can perform moving image generation, viewing of a recorded moving image, and viewing of a generated moving image by selecting a menu from a button 1001 of the user interface. To generate a moving image, the user first presses a button 1002 to select a moving image to be clipped. At this time, the user can select a moving image from moving image data stored in the image processing apparatus 120. The user can upload moving data through a network.

The user selects a person of interest in an item 1003. The person can be selected from displayed face images, or the user can press a registration button to upload an image. The image processing apparatus 120 uses the selected image as advance data of recognition processing. In the present exemplary embodiment, recognition using a face image is performed by using a person as a target, but this is illustrative, and the advance data used for the recognition may be changed depending on the object of interest. In place of the image, parameters, such as numerical values, may be input from the user interface.

In an item 1004, a part of the person of interest to be included in the clip region can be selected. Based on the selected item, end positions of the object region are used as parameters to determine the end positions of the clip region. For example, in a case where the whole body of the person of interest is captured, end positions of the object region of the whole body of the object positioned at the end are used as parameters to determine the end positions of the clip region. When a button 1005 is finally pressed, the image processing apparatus 120 starts the image clipping processing. After the processing is completed, the user can confirm a generated moving image from a screen of a generated moving image list. The user interface described in the present exemplary embodiment is illustrative, and the form of the user interface is not limited as long as the user can operate and generate a moving image based on a captured moving image.

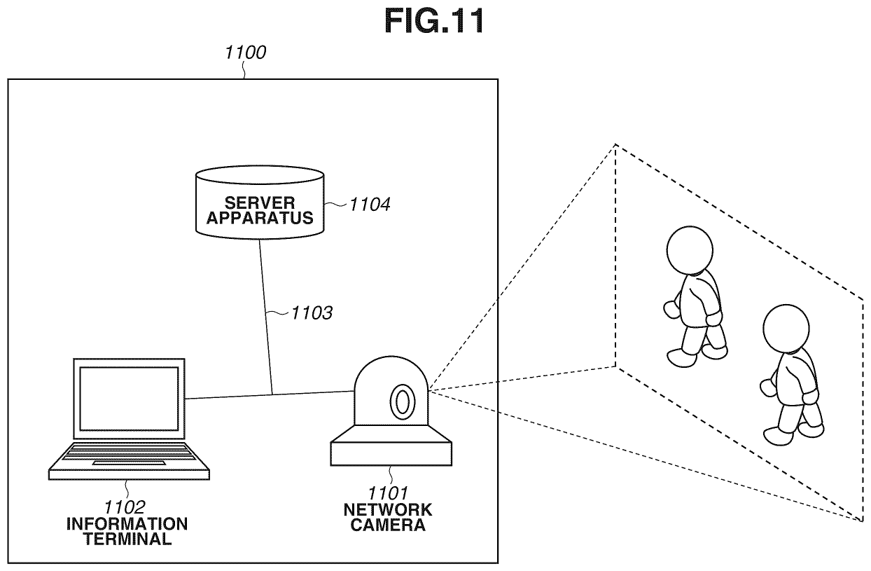

In the first exemplary embodiment, the image processing in the case where the image processing system 100 is formed of the image processing apparatus 120 and the network camera 110 is described. Image processing in a case where an image processing system 1100 is formed of a network camera 1101, information terminal 1102, and a server apparatus 1104, as illustrated in FIG. 11, is to be described. In a second exemplary embodiment, the server apparatus 1104 performs the image processing illustrated in FIG. 5 and FIG. 6.

In the present exemplary embodiment, the image processing system 1100 mainly includes the network camera 1101, the information terminal 1102, a network 1103, and the server apparatus 1104.

The network camera 1101 is a camera that can transmit a control signal through serial communication or IP communication, or transmit a moving image by an analog/digital signal. The network camera 1101 can distribute a moving image to an external apparatus, set various kinds of internal parameters, and control the camera. The network camera 1101 can record moving image data in an external memory, such as an SD card.

The information terminal 1102 is connected to the network camera 1101, and can control the camera and receive the distributed moving image. The information terminal 1102 includes an application, such as a web browser; can display the moving image distributed from the network camera 1101 and a setting screen; and can control the camera. In addition, the information terminal 1102 can be connected to the server apparatus 1104, can operate viewing of the moving image recorded in the server apparatus 1104, and can remotely control moving image generation performed in the server apparatus 1104.

The network 1103 is a network for communication of the network camera 1101, the information terminal 1102, and the server apparatus 1104. The form of communication may be wired communication or wireless communication without limitation as long as the moving image and the control signal can be transmitted by serial communication or IP communication.

The server apparatus 1104 can store a moving image captured by the camera, and can perform image clipping processing on the captured moving image to generate a moving image. The server apparatus 1104 can acquire a moving image from the network camera 1101 through the network 1103, and can store the moving image in an internal memory. The server apparatus 1104 can also acquire data from an external memory, such as an SD card, and can acquire moving image data recorded by the network camera 1101 from the external memory.

An image processing procedure in the image processing system 1100 according to the present exemplary embodiment is to be described with reference to the flowchart illustrated in FIG. 5. In step S501, the server apparatus 1104 acquires a moving image to be clipped. In the present exemplary embodiment, the moving image is acquired by receiving moving image data distributed from the network camera 1101 through the network 1103. However, the method is not limited as long as the moving image data can be acquired. For example, the network camera 1101 may record moving image data in a detachable external memory, such as an SD card, at the time of imaging, and the moving image data may be transferred to the server apparatus 1104 by using the external memory.

In step S502, the server apparatus 1104 performs object detection processing on each of the frames of the moving image data. The objects to be detected are characteristic objects, such as a person, a pattern on a background, and a signboard. These objects to be detected can be set by the user through the web browser of the information terminal 1102. The objects may be detected by using feature point detection or another method. The server apparatus 1104 can partially acquire positions of the detected objects. In step S503, the server apparatus 1104 determines an object of interest from the objects detected in each of the frames in step S502. The server apparatus 1104 labels object regions of the detected objects in each of the frames of the moving image data, and stores a frame number and the object regions in the image in association with the label.

In step S504, the server apparatus 1104 determines an image clip region based on the positions of the detected objects. The clip region is determined using the information on the object regions stored in step S503. Details of the method of determining the clip region are similar to the details of the method in the first exemplary embodiment.

In step S505, the server apparatus 1104 performs the image clipping processing on each of the frames based on the determined clip region. In step S506, the server apparatus 1104 combines all of the frames to generate one moving image. The processing then ends.

By the above-described configuration, the present exemplary embodiment can provide the technique for preventing the object of interest and the objects around the object of interest from being cut off when the image is clipped.

Although exemplary embodiments are described above, some embodiments are not limited to these exemplary embodiments, and embodiments can be variously modified and changed within the scope of the gist of the disclosure.

According to the exemplary embodiments, it is possible to provide the technique for preventing the object of interest and the objects around the object of interest from being cut off when the image is clipped.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-076735, which was filed on May 8, 2023 and which is hereby incorporated by reference herein in its entirety.

What is claimed is:

1. An image processing apparatus comprising:
one or more processors; and
one or more memories, wherein the one or more processors and the one or more memories are configured to:
acquire a first image including a plurality of objects;
detect the objects in the first image;
set an object of interest from the objects;
determine a first region in the first image to include the object of interest, based on positions of the objects;
generate a second image based on the first region determined; and
determine a respective second region, indicating a position and a region, of each of the objects in the first image.

2. The image processing apparatus according to claim 1, wherein the one or more processors and the one or more memories are further configured to determine the first region based on the second regions.

3. The image processing apparatus according to claim 2, wherein the one or more processors and the one or more memories are further configured to determine end positions of the first region to be matched with end positions of the second regions.

4. The image processing apparatus according to claim 1, wherein the one or more processors and the one or more memories are further configured to determine the first region based on any one of a number of objects included in the first region, a rate of a region corresponding to a face of the object of interest to the first region, and a rate of the first region to the first image.

5. The image processing apparatus according to claim 1, wherein the one or more processors and the one or more memories are further configured to determine the first region to maintain an aspect ratio of the first image.

6. The image processing apparatus according to claim 1, wherein, in a case where a number of objects included in the first region is greater than a threshold, the one or more processors and the one or more memories are further configured to determine the first region to cause the number of objects included in the first region to be less than the threshold.

7. The image processing apparatus according to claim 1, wherein, in a case where a rate of a size of a region corresponding to a face of the object of interest to a size of the first region is less than a preset rate, the one or more processors and the one or more memories are further configured to determine the first region by reducing a number of objects included in the first region.

8. The image processing apparatus according to claim 1, wherein, in a case where a rate of an area of the first region to an area of the first image is less than a preset rate, the one or more processors and the one or more memories are further configured to determine the first region by increasing a number of objects included in the first region.

9. The image processing apparatus according to claim 1, wherein attributes of the objects are designated by a user.

10. The image processing apparatus according to claim 1, wherein attributes of the objects include a person, an animal, and an immovable body.

11. The image processing apparatus according to claim 1, wherein the one or more processors and the one or more memories are further configured to clip the first region, from the first image.

12. A method of controlling an image processing apparatus, the method comprising:
acquiring a first image including a plurality of objects;
detecting the objects in the first image;
setting an object of interest from the detected objects;
determining a first region in the first image to include the object of interest based on positions of the detected objects; and
generating a second image based on the determined first region.

13. A non-transitory computer-readable medium that stores computer-executable instructions that, when executed by a computer, cause the computer to execute a method comprising:
acquiring a first image including a plurality of objects;
detecting the objects in the first image;
setting an object of interest from the detected objects;
determining a respective second region, indicating a position and a region, of each of the detected objects in the first image,
determining a first region in the first image to include the object of interest based on positions of the detected objects and on the second regions; and
generating a second image based on the determined first region.
